(19) United States
(12) Patent Application Publication
(10) Pub. No.: US 2018/0047504 A1
(43) Pub. Date: Feb. 15, 2018

(54) METHOD FOR MANUFACTURING R-T-B SINTERED MAGNET

(71) Applicant: HITACHI METALS, LTD., Minato-ku, Tokyo (JP)

(72) Inventors: Takeshi NISHIUCHI, Mishima-gun (JP); Yasutaka SHIGEMOTO, Mishima-gun (JP); Noriyuki NOZAWA, Mishima-gun (JP)

(21) Appl. No.: 15/549,689

(22) PCT Filed: Feb. 16, 2016
(86) PCT No.: PCT/JP2016/054422

§ 371 Date: Aug. 9, 2017

(30) Foreign Application Priority Data
Feb. 18, 2015 (JP) 2015-029205

(51) Int. Cl. H01F 41/02; C22C 38/14; H01F 1/055; C22C 38/02; C22C 28/00; C22C 33/02; C22C 38/00; C22C 38/04

(52) U.S. Cl. CPC H01F 41/0253; C22C 38/005; C22C 38/14; C22C 38/04; C22C 38/02; C22C 28/00; C22C 33/02; H01F 1/055

(57) ABSTRACT

[Problem] There is provided a method of producing a sintered R-T-B based magnet in which even the intergranular grain boundaries in the magnet interior can be made thick, which does not allow coercivity improvement effects to be significantly undermined even after a surface grinding, and which has high coercivity without the use of heavy rare-earth elements.

[Solution] It includes: a step of providing an R1-T1-A-X (where R1 is mainly Nd; T1 is mainly Fe; A is at least one of Ga, Ti, Zr, Hf, V, Nb and Mo; and X is mainly B) based sintered alloy compact which is mainly characterized in that a molar ratio of Ti/(X-2A) is not less than 13; a step of providing an R2-Ga—Cu (where R2 is mainly Pr and/or Nd and accounts for 65 mol % and not more than 95 mol %; and Cu/(Ga+Cu) is not less than 0.1 and not more than 0.9 by mole ratio) based alloy; and a step of, while allowing at least a portion of the R2-Ga—Cu based alloy to be in contact with at least a portion of a surface of the R1-T1-A-X based sintered alloy compact, performing a heat treatment at a temperature of 450° C. to 600° C.

### TECHNICAL FIELD

The present invention relates to a method for producing a sintered R-T-B based magnet.

### BACKGROUND ART

Sintered R-T-B based magnets (where R is at least one rare-earth element which always includes Nd; T is at least one transition metal element which always includes Fe; and B is boron) are known as permanent magnets with the highest performance, and are used in voice coil motors (VCM) of hard disk drives, various types of motors such as motors for electric vehicles (EV, HV, PHV, etc.) and motors for industrial equipment, home appliance products, and the like.

A sintered R-T-B based magnet is composed of a main phase which mainly consists of an R₂T₁₄B compound and a grain boundary phase (which hereinafter may be simply referred to as the “grain boundaries”) that is at the grain boundaries of the main phase. The main phase, i.e., an R₂T₁₄B compound, is a ferromagnetic phase having high magnetization, and provides a basis for the properties of a sintered R-T-B based magnet.

Coercivity H_{cJ} (which hereinafter may be simply referred to as “coercivity” or as “H_{cJ}”) of sintered R-T-B based magnets decreases at high temperatures, thus causing an irreversible flux loss. For this reason, sintered R-T-B based magnets for use in motors for electric vehicles, in particular, are required to have high H_{cJ} at high temperatures, i.e., to have higher H_{cJ} at room temperature.

It is known that H_{cJ} is improved if a light rare-earth element (mainly Nd and/or Pr) contained in the R of the R₂T₁₄B compound, i.e., the main phase, of a sintered R-T-B based magnet is partially replaced with a heavy rare-earth element (mainly Dy and/or Tb). H_{cJ} is more improved as the amount of substituted heavy rare-earth element increases.

However, replacing the light rare-earth element RL in the R₂T₁₄B compound with a heavy rare-earth element may improve the H_{cJ} of the sintered R-T-B based magnet, but decrease its remanence Bᵣ (which hereinafter may be simply referred to as “Bᵣ”). Moreover, heavy rare-earth elements, in particular Dy and the like, are scarce resource, and they yield only in limited regions. For this and other reasons, they have problems of instable supply, significantly fluctuating prices, and so on. Therefore, the recent years have seen the users' desire for improved H_{cJ} while using as little heavy rare-earth element as possible, without lowering Br.

Patent Document 1 discloses, while an R¹ᵢ-M¹ⱼ alloy (15<j≦99) of a specific composition containing an intermetallic compound phase in an amount of 70 vol % or more is allowed to be present on the surface of a sintered compact of a specific composition, performing a heat treatment for 1 minute to 30 hours in a vacuum or an inert gas, at a temperature which is equal to or less than the sintering temperature of the sintered compact. One element or two or more elements of the R¹ and M¹ contained in the alloy diffuse into the grain boundary portions inside the aforementioned sintered compact and/or into the main phase in the vicinity of the grain boundary portions. As specific examples, Patent Document 1 discloses performing a diffusion heat treatment at 800° C. for 1 hour, while allowing an Nd₃₃Al₆₇ alloy containing an NdAl₂ phase or an Nd₃₅Fe₂₅Co₂₀Al₂₀ alloy containing an Nd(Fe,Co,Al)₂ phase or the like to be in contact with a sintered compact of Nd₁₆Fe_{bal.}Co_{1.0}B_{5.3}.

Patent Document 2 discloses a method in which an Nd—Fe—B based sintered compact and a source containing Pr are placed in a container and heated, whereby Pr is supplied to the magnet interior. It is disclosed that, by optimizing conditions in the method of Patent Document 2, Pr is allowed to be present only at the grain boundaries while restraining Pr from being introduced into the main phase crystal grains, thereby improving coercivity not only at room temperature but also at high temperatures (e.g., 140° C.). As a specific example, Patent Document 2 discloses heating at 660° C. to 760° C. by using an appropriate amount of Pr metal powder.

Patent Document 3 discloses allowing an RE-M alloy which contains an M element (specifically, Ga, Mn, In) having a specific vapor pressure and whose melting point is equal to or less than 800° C. to be in contact with an RE-T-B based sintered compact, and performing a heat treatment at a temperature which is 50 to 200° C. higher than the vapor pressure curve of the M element. Through this heat treatment, the RE element permeates the compact via diffusion from the melt of the RE-M alloy. Patent Document 3 states that, as the M element evaporates during the process, it is restrained from being introduced to the magnet interior, whereby only the RE element is efficiently introduced. As a specific example, Patent Document 3 discloses using an Nd-20 at % Ga and performing a heat treatment at 850° C. for hours.

### CITATION LIST

### Patent Literature

Patent Document 1: Japanese Laid-Open Patent Publication No. 2008-263179

Patent Document 2: Japanese Laid-Open Patent Publication No. 2014-112624

Patent Document 3: Japanese Laid-Open Patent Publication No. 2014-086529

### SUMMARY OF INVENTION

### Technical Problem

The methods described in Patent Documents 1 to 3 are worth attention in that they are able to improve the coercivity of a sintered R-T-B based magnet without using any heavy rare-earth elements at all. However, in any of the above, it is only the vicinity of the magnet surface that is improved in coercivity, while there is hardly any coercivity improvement in the magnet interior. As is described in Patent Document 3, it is considered that the grain boundaries (in particular, any grain boundary that exists between two main phase portions; which may hereinafter be referred to as “intergranular grain boundaries”) drastically decrease in thickness, away from the magnet surface and toward the magnet interior, and this causes a large difference in coercivity between the vicinity of the magnet surface and the magnet interior. There is a problem in that, if the portion with improved coercivity is removed through a surface grinding or the like that is performed for adjusting the magnet dimensions in the generic magnet production steps, the coercivity improvement effects are significantly undermined.

Various embodiments of the present invention provide methods for producing a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element.

### Solution To Problem

A method for producing a sintered R-T-B based magnet according to the present invention is a method for producing a sintered R-T-B (where R is at least one rare-earth element which always includes Nd; T is at least one transition metal element which always includes Fe; and B is partially replaceable with C) based magnet, comprising:
a step of providing an R1-T1-A-X (where R1 is at least one rare-earth element which always includes Nd and accounts for not less than 27 mass % and not more than 35 mass %; T1 is Fe, or Fe and M; M is one or more selected from among Ga, Al, Si, Cr, Mn, Co, Ni, Cu, Zn, Ge and Ag; A is at least one of Ti, Zr, Hf, V, Nb and Mo; a molar ratio of [T1]/([X]−2[A]) is not less than 13.0; and X is B, where B is partially replaceable by C) based sintered alloy compact;
a step of providing an R2-Ga—Cu (where R2 is at least one rare-earth element which always includes Pr and/or Nd and accounts for not less than 65 mol % and not more than 95 mol %; and [Cu]/([Ga]+[Cu]) is not less than 0.1 and not more than 0.9 by mole ratio) based alloy; and
a step of, while allowing at least a portion of the R2-Ga—Cu based alloy to be in contact with at least a portion of a surface of the R1-T1-A-X based sintered alloy compact, performing a heat treatment at a temperature which is not less than 450° C. and not greater than 600° C. in a vacuum or an inert gas ambient.

In one embodiment, T1 in the R1-T1-A-X comprises Fe and M, where M is one or more selected from the group consisting of Al, Si, Cr, Mn, Co, Ni, Cu, Zn, Ge and Ag.

In one embodiment, a molar ratio of [T1]/([X]−2[A]) in the R1-T1-A-X based sintered alloy compact is 14.0 or more.

In one embodiment, a molar ratio of [T1]/[X] in the R1-T1-A-X based sintered alloy compact is less than 14.

In one embodiment, any heavy rare-earth element accounts for 1 mass % or less of the R1-T1-A-X based sintered alloy compact.

In one embodiment, the R1-T1-A-X based sintered alloy compact is provided by pulverizing a raw material alloy to a size of not less than 1 μm and not more than 10 μm, thereafter pressing the pulverized raw material alloy in a magnetic field, and performing sintering.

In one embodiment, no heavy rare-earth element is contained in the R2-Ga—Cu based alloy.

In one embodiment, Pr accounts for 50 mol % or more of the R2 in the R2-Ga—Cu based alloy.

In one embodiment, in the heat treatment step, an R1₂ T1₁₄ X phase in the R1-T1-A-X based sintered alloy compact reacts with a liquid phase occurring from the R2-Ga—Cu based alloy to generate an R₆ T₁₃ Z phase (where Z always includes Ga and/or Cu) at least partially inside the sintered magnet.

In one embodiment, the temperature in the step of performing a heat treatment is not less than 480° C. and not more than 540° C.

### Advantageous Effects of Invention

According to the present invention, there is provided a method for producing a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element.

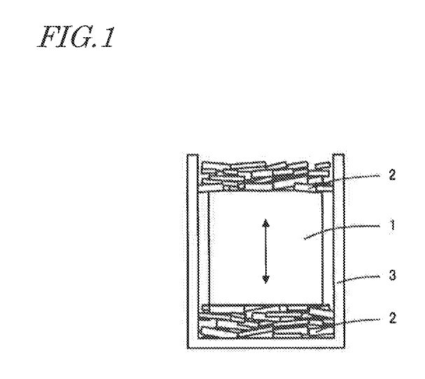

### BRIEF DESCRIPTION OF DRAWINGS

[FIG. 1] An explanatory diagram schematically showing how an R1-T1-A-X based sintered alloy compact and an R2-Ga—Cu based alloy may be placed during a heat treatment step.

### DESCRIPTION OF EMBODIMENTS

In the methods described in Patent Documents 1 and 2, a relatively high temperature, typically a temperature of 650° C. or above, has been adopted for the heat treatment. This is presumably because part of the grain boundaries existing between main phase portions of the sintered compact melts at a temperature of 650° C. or above, such that elements are introduced from the exterior through this region as a diffusion path. In other words, it is considered that the need to secure a certain amount of liquid phase in the sintered compact has made it effective to perform a relatively high-temperature treatment.

On the other hand, in the method described in Patent Document 3, Ga or the like is used to lower the melting point of the rare-earth alloy serving as a diffusion source, and, by utilizing the vapor pressure of Ga, a rare-earth element (which in Patent Document 3 is Nd) is introduced to the interior of the sintered compact, while restraining Ga from being introduced to the interior of the sintered compact. As a result of this, thick intergranular grain boundaries can be created even at a relatively low heat treatment temperature, whereby coercivity can be improved. However, in the method of Patent Document 3, it is only in the vicinity of the magnet surface that thick intergranular grain boundaries are created, and the intergranular grain boundaries in the magnet interior remain thin.

Through vigorous studies aimed at solving the above problems, the present inventors have arrived at a method which performs a heat treatment at a relatively low temperature while an R2-Ga—Cu based alloy of a specific composition such that [Cu]/([Ga]+[Cu]) is not less than 0.1 and not more than 0.9 by mole ratio is allowed to be in contact with an R1-T1-A-X based sintered alloy compact, where at least one of Ti, Zr, Hf, V, Nb and Mo is allowed to be contained as an A element in an R1-T1-X (where R1 is at least one rare-earth element which always includes Nd and accounts for not less than 27 mass % and not more than 35 mass %; T1 is Fe, or Fe and M; M is at least one selected from among Ga, Al, Si, Cr, Mn, Co, Ni, Cu, Zn, Ge and Ag; and X is B, where B is partially replaceable by C) based composition to form a boride of the A element (e.g., TiB₂ or ZrB₂), the R1-T1-A-X based sintered alloy compact being richer in T (which in the present invention is T1) and poorer in B (or B+C in the case where B is partially replaced by C; in the present invention, it is (X−2A)) (where a molar ratio of [T]/[B] is 14 or more; in the present invention, a molar ratio of [T1]/([X]−2[A]) is 14.0 or more) than R₂T₁₄B (which in the present invention is R1₂−T1₁₄−(X−2A)), i.e., the stoichiometric composition of the main phase of a commonly-available sintered R-T-B based magnet, where Xeff (i.e., an X amount excluding the amount which is consumed in making a boride=the effective X amount involved in the main phase formation) is defined as X−2A(X−2×A). With this method, a liquid phase that occurs from the R2-Ga—Cu based alloy can be introduced from the surface of the sintered compact to the interior through diffusion, via grain boundaries in the sintered compact. It has been further found that thick intergranular grain boundaries containing Ga and/or Cu can be easily formed all the way into the interior of the sintered compact. By creating such a structure, magnetic coupling between main phase crystal grains is greatly alleviated, whereby a sintered R-T-B based magnet with a very high coercivity can be obtained without using a heavy rare-earth element. Upon further studies based on these findings, it has been found that, even when a molar ratio of [T1]/([X]−2[A]) in the sintered alloy compact is 13.0 or more but less than 14.0, a high coercivity is exhibited which is close to that of a sintered R-T-B based magnet being produced by using a sintered alloy compact in which a molar ratio of [T1]/([X]−2[A]) is 14.0 or more.

(1) Step of Providing an R1-T1-A-X Based Sintered Alloy Compact

In a step of providing an R1-T1-A-X based sintered alloy compact (which may hereinafter be simply referred to as a “sintered compact”), the sintered compact has a composition such that: R1 is at least one rare-earth element which always includes Nd and accounts for not less than 27 mass % and not more than 35 mass %; T1 is Fe, or Fe and M; M is one or more selected from among Ga, Al, Si, Cr, Mn, Co, Ni, Cu, Zn, Ge and Ag; a molar ratio of [T1]/([X]−2[A]) is 13.0 or more (preferably 14 or more); and X is B, where B is partially replaceable by C.

R1 is at least one rare-earth element which always includes Nd. Besides Nd, another example of a rare-earth element may be Pr, for example. Furthermore, heavy rare-earth elements such as Dy, Tb, Gd and Ho, which are commonly used in order to improve the coercivity of a sintered R-T-B based magnet, may be contained in small amounts. However, the present invention makes it possible to obtain a sufficiently high coercivity without using the aforementioned heavy rare-earth element(s) in large amounts. Therefore, preferably, the heavy rare-earth element(s) is contained in an amount which is 1 mass % or less of the entire R1-T1-A-X based sintered alloy compact (i.e., the heavy rare-earth element accounts for 1 mass % or less in the R1-T1-A-X based sintered alloy compact), more preferably 0.5 mass % or less, and still more preferably, no heavy rare-earth element is contained (i.e., substantially 0 mass %).

It is preferable that R1 accounts for not less than 27 mass % and not more than 35 mass % of the entire R1-T1-A-X based sintered alloy compact. If R1 is less than 27 mass %, a liquid phase will not sufficiently occur in the sintering process, and it will be difficult for the sintered compact to become adequately dense in texture. On the other hand, if R1 exceeds 35 mass %, effects of the present invention will be obtained, but the alloy powder during the production steps of the sintered compact will be very active, and considerable oxidization, ignition, etc. of the alloy powder may possibly occur; therefore, it is preferably 35 mass % or less. More preferably, R1 is not less than 28 mass % and not more than 33 mass %; and still more preferably, R1 is not less than 28.5 mass % and not more than 32 mass %.

T1 is Fe, or Fe and M; and M is one or more selected from among Ga, Al, Si, Cr, Mn, Co, Ni, Cu, Zn, Ge and Ag. In other words, T1 may be Fe alone (although inevitable impurities may be included), or consist of Fe and M (although inevitable impurities may be included). When T1 consists of Fe and M, it is preferable that the Fe amount accounts for 80 mol % or more in the entire T1. When T1 consists of Fe and M, M may be one or more selected from among Al, Si, Cr, Mn, Co, Ni, Cu, Zn, Ge and Ag.

A is at least one of Ti, Zr, Hf, V, Nb and Mo. The A element easily forms a very stable boride with the B (boron) in X, thus lowering the effective X amount involved in the main phase formation (X−2A). The A content may be set so as to satisfy the below-described relationship [T1]/([X]−2[A]). Although depending on the particular kind of element that is used, A preferably accounts for not less than 0.01 mass % and not more than 1.0 mass %, and more preferably not less than 0.05 mass % and not more than 0.8 mass %, of the entire R1-T1-A-X based sintered alloy compact.

X is B, where B is partially replaceable by C (carbon). In the case where B is partially replaced by C, it may not only be what is purposely added during the production steps of the sintered compact, but may also include any solid or liquid lubricant that is used during the production steps of the sintered compact, and what originates in the dispersion medium or the like (in the case of wet forming) and remains in the sintered compact. The C that originates from a lubricant, a dispersion medium, etc. is inevitable, but it can still be controlled to within a certain range (i.e., adjustment of added amounts or a decarbonization treatment); therefore, by taking these amounts into consideration, the B amount and the C amount to be purposely added may be prescribed so as to satisfy the below-described relationship [T1]/([X]−2[A]). In order to purposely add C during the production steps of the sintered compact, for example, C may be added as a raw material when producing the raw material alloy (i.e., a raw material alloy containing C may be produced); a C source (carbon source), e.g., a specific amount of carbon black, may be added to the alloy powder during the production steps (i.e., a coarse-pulverized powder existing before the below-described pulverization with a jet mill or the like, or a fine-pulverized powder existing after the pulverization); and so on. Note that B accounts for preferably 80 mol % or more, and more preferably 90 mol % or more, of the entire X. Moreover, X preferably accounts for not less than 0.8 mass % and not more than 1.3 mass % of the entire R1-T1-A-X based sintered alloy compact. When X is less than 0.8 mass %, effects of the present invention will still be obtained, but Bᵣ will be greatly reduced, which is not preferable. On the other hand, when X exceeds 1.3 mass %, it takes a large amount of A being added to ensure that the molar ratio of [T1]/([X]−2[A]) as described below is equal to or greater than 13.0, thus greatly lowering Bᵣ, which is not preferable. More preferably, X accounts for not less than 0.85 mass % and not more than 1.1 mass %, and still more preferably, not less than 0.9 mass % and not more than 1.0 mass %.

The aforementioned T1, X and A are prescribed so that a molar ratio of [T1]/([X]−2[A]) is 14 or more. X−2A is the effective X amount that is involved in the main phase formation when A forms a 1:2 boride with X(B) (e.g., TiB2 or ZrB2). This condition indicates a molar ratio similar to that between [T]/[B] (which in the present invention is [T1]/([X]−2[A]))(=14) in R₂T₁₄B (which in the present invention is R1₂−T1₁₄−(X−2A)), i.e., the stoichiometric composition of the main phase of a commonly-available sintered R-T-B based magnet, or being richer in T (which in the present invention is T1) and poorer in B (which in the present invention is (X−2A)) than that. As described above, the inventors had believed at the outset of the invention that, when the molar ratio of [T1]/([X]−2[A]) was less than 14, as in the composition of a commonly-available sintered R-T-B based magnet (i.e., poorer in T (which in the present invention is T1) and richer in B (which in the present invention is (X−2A)) than the molar ratio of [T]/[B] (which in the present invention is [T1]/([X]−2[A])) in the stoichiometric composition R₂T₁₄B), the vicinity of the magnet surface and the intergranular grain boundaries in the magnet interior could not be made thick in the sintered R-T-B based magnet to be finally obtained, and thus it would be difficult to obtain a sintered R-T-B based magnet with high coercivity without the use of heavy rare-earth elements. However, they found in further studies that, even when poorer in T and richer in B (which in the present invention is (X−2A)) than the molar ratio of [T]/[B] (which in the present invention is [T1]/([X]−2[A])) in R₂T₁₄B, i.e., the stoichiometric composition of the main phase of a commonly-available sintered R-T-B based magnet, a molar ratio of [T1]/([X]−2[A]) that is 13.0 or more can still provide a coercivity which, if not exceeding what will be obtained by using a sintered alloy compact of 14 or greater, comes very close to it.

In other words, the molar ratio of [T1]/([X]−2[A]) being set to 14 or more is based on the notion that the B and C composing X that remain after A has formed a 1:2 boride with B (e.g., TiB₂ or ZrB₂) will entirely be consumed in making the main phase. Generally speaking, however, X (in particular, C) will not entirely be consumed in the main phase formation, but will also be present in the grain boundary phase. Thus it has been found that, in actuality, [X] may be set slightly greater (i.e., poorer in T and richer in B); that is, the molar ratio of [T1]/([X]−2[A]) may be set 13.0 or more, and high coercivity can still be obtained. It is difficult to determine an accurate ratio by which X is distributed between the main phase and the grain boundary phase; however, when the molar ratio of [T1]/([X]−2[A]) is 13.0 or more, given that the X which is being consumed in the main phase formation has a mole ratio [X′] (where [X′]≦[X]), it is considered that [T1]/[X′] is 14 or more. If the molar ratio of [T1]/([X]−2[A]) is less than 13.0, the aforementioned [T1]/[X′] may not be made 14 or more, in which case the intergranular grain boundaries in the vicinity of the magnet surface and in the magnet interior cannot be made thick in the sintered R-T-B based magnet that is finally obtained, thus making it difficult to obtain a sintered R-T-B based magnet with high coercivity without the use of heavy rare-earth elements. While the molar ratio of [T1]/([X]−2[A]) being 13.0 or more provides high coercivity as described above, in order to attain even higher coercivity and to stably attain high coercivity in a mass production process, the molar ratio of [T1]/([X]−2[A]) is more preferably 13.3 or more, and still more preferably 14 or more.

In the R1-T1-A-X based sintered alloy compact the molar ratio of [T1]/[X] is preferably less than 14. This condition indicates a relationship between X ([the X amount (X−2A) that is contained in the main phase]+[the X amount that is contained in the boride]) and T1 in the entire R1-T1-A-X based sintered alloy compact. Specifically, this means being poorer in T1 and richer in X than the [T]/[B] (which in the present invention is the molar ratio of [T1]/([X]−2[A]))(=14) in R₂T₁₄B (which in the present invention is R1₂−T1₁₄−(X−2A)), i.e., the stoichiometric composition of the main phase of a commonly-available sintered R-T-B based magnet. If the molar ratio of [T1]/[X] is 14 or more, i.e., richer in T1 and poorer in X, the main phase will account for a lowered ratio, thus causing Bᵣ to be greatly lowered in the finally-obtained sintered R-T-B based magnet, which is not preferable.

An R1-T1-A-X based sintered alloy compact can be provided by using a generic method for producing a sintered R-T-B based magnet, such as an Nd—Fe—B based sintered magnet. As one example, a raw material alloy which is produced by a strip casting method or the like may be pulverized to not less than 1 μm and not more than 10 μm by using a jet mill or the like, thereafter pressed in a magnetic field, and then sintered at a temperature of not less than 900° C. and not more than 1100° C. In the resultant sintered compact, it does not matter if the coercivity is very low. If the pulverized particle size (having a central value of volume as obtained by an airflow-dispersion laser diffraction method=D₅₀) of the raw material alloy is less than 1 μm, it becomes very difficult to produce pulverized powder, thus resulting in a greatly reduced production efficiency, which is not preferable. On the other hand, if the pulverized particle size exceeds 10 μm, the sintered R-T-B based magnet as finally obtained will have too large a crystal grain size to achieve high coercivity, which is not preferable, even though thick intergranular grain boundaries may be formed.

So long as the aforementioned conditions are satisfied, the R1-T1-A-X based sintered alloy compact may be produced from one kind of raw material alloy (a single raw-material alloy), or through a method of using two or more kinds of raw material alloys and mixing them (blend method). The A element may be contained in a raw material alloy (e.g., R1, T1, X, and a metal of the A element or an alloy or compound that contains the A element may be blended into a certain composition, which may thereafter be made into a raw material alloy by a strip casting method or the like); or, a coarse-pulverized powder or a fine-pulverized powder of a raw material alloy that contains no A element or some A element may be mixed with a powder of a metal of the A element or a powder of an alloy or compound that contains the A element. Moreover, the R1-T1-A-X based sintered compact may contain inevitable impurities, such as O (oxygen), N (nitrogen), and C (carbon), that may exist in the raw material alloy or introduced during the production steps.

(2) Step of Providing an R2-Ga—Cu Based Alloy

In a step of providing an R2-Ga—Cu based alloy, the R2-Ga—Cu based alloy has a composition such that: R2 is at least one rare-earth element which always includes Pr and/or Nd and accounts for not less than 65 mol % and not more than 95 mol %; and [Cu]/([Ga]+[Cu]) is not less than 0.1 and not more than 0.9 by mole ratio. The R2-Ga—Cu based alloy always contains both Ga and Cu. If not both of Ga and Cu are contained, the intergranular grain boundaries in the vicinity of the magnet surface and in the magnet interior cannot be made thick in the sintered R-T-B based magnet that is finally obtained, thus making it difficult to obtain a sintered R-T-B based magnet with high coercivity without the use of heavy rare-earth elements.

R2 is at least one rare-earth element which always includes Pr and/or Nd. Herein, it is preferable that 90 mol % or more of the entire R2 is Pr and/or Nd, more preferable that 50 mol % or more of the entire R2 is Pr, and still more preferable that R2 is Pr alone (although inevitable impurities may be included). R2 may contain small amounts of heavy rare-earth elements such as Dy, Tb, Gd and Ho, which are commonly used in order to improve the coercivity of a sintered R-T-B based magnet. However, according to the present invention, a sufficiently high coercivity can be obtained without using the aforementioned heavy rare-earth element(s) in large amounts. Therefore, the aforementioned heavy rare-earth element(s) is contained in an amount which is preferably 10 mass % or less of the entire R2-Ga—Cu based alloy (i.e., the heavy rare-earth element(s) accounts for 10 mass % or less in the R2-Ga—Cu based alloy), more preferably 5 mass % or less, and still more preferably not contained at all (substantially 0 mass %).

When R2 accounts for not less than 65 mol % and not more than 95 mol % of the entire R2-Ga—Cu based alloy and [Cu]/([Ga]+[Cu]) is not less than 0.1 and not more than 0.9 by mole ratio, there is provided a sintered R-T-B based magnet in which the intergranular grain boundaries can be made thick not only in the vicinity of the magnet surface but also in the magnet interior, such that coercivity improvement effects are not significantly undermined even after a surface grinding for adjusting the magnet dimensions, and which provides high coercivity without using a heavy rare-earth element. More preferably, R2 accounts for not less than 70 mol % and not more than 90 mol % of the entire R2-Ga—Cu based alloy, and still more preferably not less than 70 mol % and not more than 85 mol %. Moreover, [Cu]/([Ga]+[Cu]) is more preferably not less than 0.2 and not more than 0.8 by mole ratio, and still more preferably not less than 0.3 and not more than 0.7.

The R2-Ga—Cu based alloy may contain small amounts of Al, Si, Ti, V, Cr, Mn, Co, Ni, Zn, Ge, Zr, Nb, Mo, Ag, and the like. A small amount of Fe may be contained, and effects of the present invention can still be obtained when Fe is contained in an amount of 20 mass % or less. However, if the Fe content exceeds 20 mass %, coercivity may be lowered. Moreover, inevitable impurities such as O (oxygen), N (nitrogen), C (carbon), and the like may be contained.

The R2-Ga—Cu based alloy can be provided by a method of producing a raw material alloy that is adopted in generic methods for producing a sintered R-T-B based magnet, e.g., a mold casting method, a strip casting method, a single roll rapid quenching method (a melt spinning method), an atomizing method, or the like. Moreover, the R2-Ga—Cu based alloy may be what is obtained by pulverizing an alloy obtained as above with a known pulverization means such as a pin mill.

(3) Step of Heat Treatment

While at least a portion of the R2-Ga—Cu based alloy that has been provided as above is allowed to be in contact with at least a portion of the surface of the R1-T1-A-X based sintered alloy compact that has been provided as above, a heat treatment is performed in a vacuum or an inert gas ambient, at a temperature which is not less than 450° C. and not greater than 600° C. As a result, a liquid phase occurs from the R2-Ga—Cu based alloy, and this liquid phase is introduced from the surface of the sintered compact to the interior through diffusion via grain boundaries in the sintered compact, so that thick intergranular grain boundaries containing Ga and Cu can be easily formed all the way into the interior of the sintered compact between crystal grains of the main phase, i.e., the R1₂T1₁₄(X−2A) phase, whereby magnetic coupling main phase crystal grains is greatly alleviated. As a result, a sintered R-T-B based magnet with a very high coercivity can be obtained without the use of heavy rare-earth elements. The temperature at which to conduct the heat treatment is preferably not less than 480° C. and not more than 540° C. A higher coercivity can be attained.

In the aforementioned step of heat treatment, the R2-Ga—Cu based alloy alone may be placed in contact with at least a portion of the surface of the R1-T1-A-X based sintered alloy compact, or methods described in Patent Documents 1 to 3 above may be adopted, e.g., a method which disperses a powder of R2-Ga—Cu based alloy in an organic solvent or the like, and applies this onto the surface of the R1-T1-A-X based sintered alloy compact.

The heat treatment involves retaining a temperature which is not less than 450° C. and not more than 600° C., then followed by cooling, in a vacuum or an inert gas ambient. By performing a heat treatment at a temperature which is not less than 450° C. and not more than 600° C., at least a portion of the R2-Ga—Cu based alloy is melted, whereby the generated liquid phase is introduced from the surface of the sintered compact to the interior through diffusion via grain boundaries in the sintered compact, whereby thick intergranular grain boundaries can be formed. If the heat treatment temperature is less than 450° C., no liquid phase occurs at all, so that thick intergranular grain boundaries cannot be obtained. If it exceeds 600° C., it also becomes difficult to form thick intergranular grain boundaries. The heat treatment temperature is preferably not less than 460° C. and not more than 570° C., and more preferably not less than 480° C. and not more than 540° C. The reason why it becomes difficult to form thick intergranular grain boundaries when a heat treatment is performed at a temperature exceeding 600° C. is currently unknown, but presumably at work is the kinetics concerning dissolution of the main phase caused by the liquid phase which is introduced in the sintered compact, and generation of the R₆T₁₃Z phase (where R is at least one rare-earth element which always includes Nd; T is at least one transition metal element which always includes Fe; and Z always includes Ga and/or Cu), etc. The heat treatment time is preferably not less than 5 minutes and not more than 10 hours, more preferably not less than 10 minutes and not more than 7 hours, and still more preferably not less than 30 minutes and not more than 5 hours.

The aforementioned heat treatment temperature of not less than 450° C. and not more than 600° C. is essentially equal to the temperature of a usual heat treatment for improving coercivity of a sintered R-T-B based magnet. Therefore, after performing a heat treatment at a temperature which is not less than 450° C. and not more than 600° C., it is not always required to perform a heat treatment for improving coercivity. Moreover, the heat treatment temperature of not less than 450° C. and not more than 600° C. is a very low temperature as compared to the temperatures of the diffusion heat treatments performed in Patent Documents 1 to 3 above. As a result, the R2-Ga—Cu based alloy component is restrained from diffusing into the interior of the main phase crystal grains. For example, in the case where Pr alone is used for the R2, a heat treatment temperature exceeding 600° C. will easily allow Pr to be introduced to the outermost portion of the main phase crystal grains, this resulting in a problematic decrease of temperature dependence of coercivity. At a heat treatment temperature of not less than 450° C. and not more than 600° C., such problems are greatly suppressed.

The sintered R-T-B based magnet which is obtained through the step of heat treatment may be subjected to known surface treatments, e.g., known machining such as severing or cutting, or plating to confer anticorrosiveness.

There are still unclear aspects of the mechanism by which thick intergranular grain boundaries are formed between crystal grains of the main phase to result in a very high coercivity. Based on the findings which have so far been available, the mechanism as believed by the present inventors will be described below. It must be noted that the following description of the mechanism is not intended to limit the scope of the present invention.

Through detailed studies, the inventors have come to believe that: Cu, by being present in the liquid phase occurring through the heat treatment, lowers the interfacial energy between the main phase and the liquid phase, and thus contributes to efficient introduction of the liquid phase from the surface of the sintered compact to the interior via intergranular grain boundaries; and that, Ga, by being present in the liquid phase which has been introduced in the intergranular grain boundaries, causes the surface vicinity of the main phase to be dissolved, and thus contributes to formation of thick intergranular grain boundaries.

Furthermore, as described earlier, by ensuring that the R1-T1-A-X based sintered alloy compact has a composition which is richer in T1 and poorer in (X−2A) than the stoichiometric composition (R1₂T1₁₄(X−2A)), i.e., the molar ratio of [T1]/([X]−2[A]) is 13 or more, thick intergranular grain boundaries will be easily obtained through the heat treatment. This is presumably because, in the aforementioned composition range, the liquid phase occurring from the R2-Ga—Cu alloy permeates the intergranular grain boundaries in the sintered compact, and the main phase in the vicinity of intergranular grain boundaries in the sintered compact becomes dissolved due to the aforementioned effects of Ga, these easily generating an R₆T₁₃Z phase (Z always includes Ga and/or Cu) at a very low temperature of 600° C. or below and becoming stable; consequently, thick intergranular grain boundaries are maintained even after cooling, thus resulting in a very high coercivity being exhibited.

On the other hand, if the R1-T1-A-X based sintered alloy compact has a composition which is poorer in T1 and richer in (X−2A) than the stoichiometric composition (R1₂T1₁₄(X−2A)), thick intergranular grain boundaries will be difficult to be obtained. This is presumably because the main phase (R1₂T1₁₄(X−2A) phase) which has once dissolved is likely to again precipitate as the main phase, this preventing the grain boundaries from becoming thick.

In the aforementioned R₆T₁₃Z phase (R₆T₁₃Z compound), R is at least one rare-earth element which always includes Pr and/or Nd; T is at least one transition metal element which always includes Fe; and Z always includes Ga and/or Cu. A representative R₆T₁₃Z compound is an Nd₆Fe₁₃Ga compound. Moreover, the R₆T₁₃Z compound has an La₆Co₁₁Ga₃ type crystal structure. Depending on its state, the R₆T₁₃Z compound may have taken the form of an R₆T₁₃₋δZ₁₊δ compound. Even in the case where Z is Ga alone, if Cu, Al and Si are contained in the sintered R-T-B based magnet, it may have taken the form of R₆T₁₃₋δ(Ga_{1-x-y-z}CuₓAl_{y}Si_{z})₁₊δ.

### EXAMPLES

The present invention will be described in more detail by way of Examples; however, the present invention is not limited thereto.

### Experimental Example 1

[Providing R1-T1-A-X Based Sintered Alloy Compact]

By using an Nd metal, a ferroboron alloy, a ferrocarbon alloy, and electrolytic iron (where each metal had a purity of 99% or more), the composition (without paying attention to Ti, Al, Si and Mn) of a sintered compact was adjusted to result in the compositions of Labels 1-A through 1-F shown in Table 1. These raw materials were melted and cast by a strip casting method, whereby raw material alloys in the form of flakes having a thickness of 0.2 to 0.4 mm were obtained. After each resultant raw material alloy in flake form was hydrogen-pulverized, it was subjected to a dehydrogenation treatment of heating to 550° C. in a vacuum and then cooling, whereby a coarse-pulverized powder was obtained. Next, to the resultant coarse-pulverized powder, zinc stearate was added as a lubricant in an amount of 0.04 mass % relative to 100 mass % of coarse-pulverized powder; after mixing, an airflow crusher (jet mill machine) was used to effect dry milling in a nitrogen jet, whereby a fine-pulverized powder (alloy powder) with a particle size D₅₀ of 4 μm was obtained. Note that the particle size D₅₀ is a central value of volume (volume median particle diameter) as obtained by a laser diffraction method by airflow dispersion technique.

To the fine-pulverized powder, a TiH₂ powder with a D₅₀ of about 5 μm was added and mixed so that Ti in the sintered compact resulted in the compositions of Labels 1-A to 1-F shown in Table 1, and zinc stearate was further added as a lubricant in an amount of 0.05 mass % relative to 100 mass % of fine-pulverized powder; after mixing, the fine-pulverized powder was pressed in a magnetic field, whereby a compact was obtained. As a pressing apparatus, a so-called orthogonal magnetic field pressing apparatus (transverse magnetic field pressing apparatus) was used, in which the direction of magnetic field application ran orthogonal to the pressurizing direction.

In a vacuum, the resultant compact was sintered for 4 hours at not less than 1020° C. and not more than 1080° C. (for each sample, a temperature was selected at which a sufficiently dense texture would result through sintering) and thereafter rapidly cooled, whereby an R1-T1-A-X based sintered alloy compact was obtained. Each resultant sintered compact had a density of 7.5 Mg/m³ or more. The components in the resultant sintered compacts and results of gas analysis (C (carbon amount)) thereof proved to be as shown in Table 1. The respective components in Table 1 were measured by using Inductively Coupled Plasma Optical Emission Spectroscopy (ICP-OES). The C (carbon amount) was measured by using a gas analyzer based on a combustion-infrared absorption method.

In Table 1, “[T1]/([X]−2[A])” is a ratio between T1 and (X−2A) (a/(b−2×c)), derived by using: (a) a total of values resulting from dividing an analysis value (mass %) of each element composing T1 (including inevitable impurities, which in this Experimental Example are Al, Si and Mn) by the atomic weight of that element; (b) a total of values resulting from dividing analysis values (mass %) of B and C by the atomic weights of these elements; and (c) a total of values resulting from dividing an analysis value (mass %) of each element (which in this Experimental Example is Ti) composing A by the atomic weight of that element. The same also applies to all of the tables below. Note that each composition in Table 1 does not total to 100 mass %. This is because, as described earlier, a different method of analysis is employed for each component, and further because components other than the components listed in Table 1 (e.g., O (oxygen), N (nitrogen), and the like) exist. The same also applies to the other tables.

TABLE 1

| | R1—T1—A—X based sintered alloy compact composition | | | | | | | | | | | |
|---|---|---|---|---|---|---|---|---|---|---|---|---|
| | (mass %) | | | | | | | | | | | |
| | R1 | | T1 | | | | A | X | | R1 | [T1]/([X] − | |
| Label | Nd | Pr | Fe | Al | Si | Mn | Ti | B | C | (mass %) | 2[A]) | [T1]/[X] |
| 1-A | 30.7 | 0.11 | 67.1 | 0.03 | 0.05 | 0.04 | 0 | 0.96 | 0.09 | 30.8 | 12.5 | 12.5 |
| 1-B | 30.8 | 0.11 | 67.0 | 0.03 | 0.05 | 0.04 | 0.08 | 0.96 | 0.09 | 30.9 | 12.9 | 12.5 |
| 1-C | 30.8 | 0.12 | 66.9 | 0.04 | 0.05 | 0.04 | 0.14 | 0.96 | 0.09 | 30.9 | 13.3 | 12.5 |
| 1-D | 30.7 | 0.13 | 66.8 | 0.04 | 0.06 | 0.04 | 0.22 | 0.96 | 0.08 | 30.8 | 14.0 | 12.7 |
| 1-E | 30.5 | 0.11 | 66.9 | 0.03 | 0.05 | 0.04 | 0.14 | 0.98 | 0.10 | 30.6 | 12.9 | 12.2 |
| 1-F | 30.5 | 0.11 | 66.9 | 0.04 | 0.05 | 0.04 | 0.24 | 0.97 | 0.09 | 30.6 | 13.8 | 12.5 |

[Providing R2-Ga—Cu Based Alloy]

By using a Pr metal, a Ga metal, and a Cu metal (where each metal had a purity of 99% or more), the composition of an alloy was adjusted to result in the composition of Label 1-a shown in Table 2, and these raw materials were dissolved; thus, by a single roll rapid quenching method (melt spinning method), an alloy in ribbon or flake form was obtained. Using a mortar, the resultant alloy was pulverized in an argon ambient, and thereafter was passed through a sieve with an opening of 425 μm, thereby providing an R2-Ga—Cu based alloy. The composition of the resultant R2-Ga—Cu based alloy is shown in Table 2.

TABLE 2

| | R2-Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 1-a | 75 | 12.5 | 12.5 | 75 | 0.5 |

[Heat Treatment]

The R1-T1-A-X based sintered alloy compacts of Labels 1-A through 1-F in Table 1 were severed and cut into 2.4 mm×2.4 mm×2.4 mm cubes. Next, as shown in FIG. 1, in a processing container 3 made of niobium foils, the R2-Ga—Cu based alloy of Label 1-a shown in Table 2 was placed above and below each of the R1-T1-A-X based sintered alloy compacts of Labels 1-A through 1-F, in such a manner that mainly a face which was perpendicular to the alignment direction (i.e., the direction indicated by arrowheads in the figure) of the R1-T1-A-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 3 by using a tubular flow furnace, followed by cooling. In order to remove any thickened portion in the R2-Ga—Cu based alloy existing in the surface vicinity of each sample after the heat treatment, a surface grinder was used to cut 0.2 mm off the entire surface of each sample, whereby samples respectively in the form of a 2.0 mm×2.0 mm×2.0 mm cube (sintered R-T-B based magnet) were obtained.

[Sample Evaluations]

The resultant samples were set in a vibrating-sample magnetometer (VSM: VSM-5SC-10HF manufactured by TOEI INDUSTRY CO., LTD.) including a superconducting coil, and after applying a magnetic field up to 4 MA/m, the magnetic hysteresis curve of the sintered compact in the alignment direction was measured while sweeping the magnetic field to −4 MA/m. Values of coercivity (H_{cJ}) as obtained from the resultant hysteresis curves are shown in Table 3. It can be seen from Table 3 that high H_{cJ} is obtained when the molar ratio of [T1]/([X]−2[A]) in the R1-T1-A-X based sintered alloy compact is 13.0 or more.

TABLE 3

| | fabrication conditions | | | | | | | | |
|---|---|---|---|---|---|---|---|---|---|
| | R1-T1-A-X based sintered | | | R2-Ga—Cu based alloy | | | | | |
| | alloy compact composition | | | composition | | | | | |
| Sample | | R1 | [T1]/ | | R2 | [Cu]/ | heat | HcJ | |
| No. | Label | (mass %) | ([X] − 2[A]) | Label | (mol %) | ([Ga] + [Cu]) | treatment | (kA/m) | NOTES |
| 1-1 | 1-A | 30.8 | 12.5 | 1-a | 75 | 0.5 | 500° C. × | 870 | Comparative |
| | | | | | | | 4 h | | Example |
| 1-2 | 1-B | 30.9 | 12.9 | 1-a | 75 | 0.5 | 500° C. × | 1030 | Comparative |
| | | | | | | | 4 h | | Example |
| 1-3 | 1-C | 30.9 | 13.3 | 1-a | 75 | 0.5 | 500° C. × | 1890 | Example of |
| | | | | | | | 4 h | | Invention |
| 1-4 | 1-D | 30.8 | 14.0 | 1-a | 75 | 0.5 | 500° C. × | 2090 | Example of |
| | | | | | | | 4 h | | Invention |
| 1-5 | 1-E | 30.6 | 12.9 | 1-a | 75 | 0.5 | 500° C. × | 975 | Comparative |
| | | | | | | | 4 h | | Example |
| 1-6 | 1-F | 30.6 | 13.8 | 1-a | 75 | 0.5 | 500° C. × | 2015 | Example of |
| | | | | | | | 4 h | | Invention |

Among the samples shown in Table 3, a cross section of Sample No. 1-4 (an example of the present invention) featuring the R1-T1-A-X based sintered alloy compact of Label 1-D having a molar ratio of [T1]/([X]−2[A]) of 13.0 or more and a cross section of Sample No. 1-1 (Comparative Example) featuring the R1-T1-A-X based sintered alloy compact of Label 1-A having a molar ratio of [T1]/([X]−2[A]) of less than 13.0 were observed with a scanning electron microscope (SEM: 54500 manufactured by Hitachi, Ltd.). The results indicated that thick intergranular grain boundaries of 100 nm or more had been formed in Sample No. 1-4 (an example of the present invention), from the vicinity of the magnet surface to the central portion of the magnet. On the other hand, in Sample No. 1-1 (Comparative Example), thick intergranular grain boundaries had only been formed in the vicinity of the magnet surface. Furthermore, a cross section of Sample No. 1-4, which is an example of the present invention, was analyzed by energy dispersive X-ray spectroscopy (EDX: HITS4800 manufactured by Hitachi, Ltd.), whereby Ga and Cu were detected also in the grain boundaries of the magnet central portion, a portion thereof being regarded as an R₆T₁₃Z phase containing Ga and Cu, based on its contents.

### Experimental Example 2

A plurality of R1-T1-A-X based sintered alloy compacts were produced by a similar method to Experimental Example 1, except that the composition (without paying attention to Ti, Al, Si and Mn; Ti was added and mixed in the form of a TiH₂ powder with a D₅₀ of about 5 μm to the fine-pulverized powder so that a sintered compact composition as shown in Table 4 resulted) of a sintered compact was adjusted to result in the composition of Label 2-A shown in Table 4.

TABLE 4

| | R1-T1-A-X based sintered alloy compact composition | | | | | | | | | | | |
|---|---|---|---|---|---|---|---|---|---|---|---|---|
| | (mass %) | | | | | | | | | | [T1]/ | |
| | R1 | | T1 | | | | A | X | | R1 | ([X] − | |
| Label | Nd | Pr | Fe | Al | Si | Mn | Ti | B | C | (mass %) | 2[A]) | [T1]/[X] |
| 2-A | 30.7 | 0.13 | 66.8 | 0.04 | 0.06 | 0.04 | 0.22 | 0.96 | 0.08 | 30.8 | 14.0 | 12.7 |

R2-Ga—Cu based alloys were produced by a similar method to Experimental Example 1, except for being adjusted so that the alloys had compositions Labels 2-a through 2-u shown in Table 5.

TABLE 5

| | R2-Ga—Cu based | | | | | |
|---|---|---|---|---|---|---|
| | alloy composition (mol %) | | | | | |
| Label | Nd | Pr | Ga | Cu | R2 (mol %) | [Cu]/([Ga] + [Cu]) |
| 2-a | 0 | 100 | 0 | 0 | 100 | — |
| 2-b | 0 | 97 | 1.5 | 1.5 | 97 | 0.5 |
| 2-c | 0 | 95 | 2.5 | 2.5 | 95 | 0.5 |
| 2-d | 0 | 90 | 5 | 5 | 90 | 0.5 |
| 2-e | 0 | 85 | 7.5 | 7.5 | 85 | 0.5 |
| 2-f | 0 | 75 | 12.5 | 12.5 | 75 | 0.5 |
| 2-g | 0 | 70 | 15 | 15 | 70 | 0.5 |
| 2-h | 0 | 60 | 20 | 20 | 60 | 0.5 |
| 2-i | 0 | 50 | 25 | 25 | 50 | 0.5 |
| 2-j | 0 | 75 | 25 | 0 | 75 | 0 |
| 2-k | 0 | 75 | 22.5 | 2.5 | 75 | 0.1 |
| 2-l | 0 | 75 | 20 | 5 | 75 | 0.2 |
| 2-m | 0 | 75 | 17.5 | 7.5 | 75 | 0.3 |
| 2-n | 0 | 75 | 7.5 | 17.5 | 75 | 0.7 |
| 2-o | 0 | 75 | 5 | 20 | 75 | 0.8 |
| 2-p | 0 | 75 | 2.5 | 22.5 | 75 | 0.9 |
| 2-q | 0 | 75 | 0 | 25 | 75 | 1 |
| 2-r | 18.75 | 56.25 | 12.5 | 12.5 | 75 | 0.5 |
| 2-s | 56.25 | 18.75 | 12.5 | 12.5 | 75 | 0.5 |
| 2-t | 75 | 0 | 12.5 | 12.5 | 75 | 0.5 |
| 2-u | 0 | 90 | 1 | 9 | 90 | 0.9 |

After the plurality of R1-T1-A-X based sintered alloy compacts were processed similarly to Experimental Example 1, the R2-Ga—Cu based alloys of Labels 2-a through 2-u and the R1-T1-A-X based sintered alloy compact of Label 2-A were placed so as to be in contact with each other in a manner similar to Experimental Example 1, and a heat treatment and processing were performed similarly to Experimental Example 1 except for adopting the heat treatment temperatures shown in Table 6, whereby samples (sintered R-T-B based magnets) were obtained. The resultant samples were measured by a method similar to Experimental Example 1, thereby determining coercivity (H_{cJ}). The results are shown in Table 6. Note that Table 6 shows results of the conditions that provided the higher coercivity between a heat treatment at 500° C. and a heat treatment at 600° C. As indicated in Table 6, high H_{cJ} was obtained when R2 in the R2-Ga—Cu based alloy was not less than 65 mol % and not more than 95 mol % and the molar ratio of [Cu]/([Ga]+[Cu]) was not less than 0.1 and not more than 0.9. Regarding R2, high H_{cJ} was obtained when Pr accounted for 50 mol % or more in the entire R2 (compare Sample No. 2-18 against Sample Nos. 2-19 and 2-20); higher H_{cJ} was obtained when R2 was Pr alone (disregarding any other rare-earth elements at impurity levels); and highest H_{cJ} was obtained particularly when Label 2-f (Pr₇₅Ga_{12.5}Cu_{12.5}(mol %)) was used as the R2-Ga—Cu based alloy.

TABLE 6

| | fabrication conditions | | | | | | | | |
|---|---|---|---|---|---|---|---|---|---|
| | R1-T1-A-X based sintered | | | R2-Ga—Cu based alloy | | | | | |
| | alloy compact composition | | | composition | | | | | |
| sample | | R1 | [T1]/ | | R2 | [Cu]/ | heat | HcJ | |
| No. | Label | (mass %) | ([X] − 2[A]) | Label | (mol %) | ([Ga] + [Cu]) | treatment | (kA/m) | NOTES |
| 2-1 | 2-A | 30.8 | 14.0 | 2-a | 100 | — | 500° C. × 4 h | 63 | Comparative |
| | | | | | | | | | Example |
| 2-2 | 2-A | 30.8 | 14.0 | 2-b | 97 | 0.5 | 500° C. × 4 h | 117 | Comparative |
| | | | | | | | | | Example |
| 2-3 | 2-A | 30.8 | 14.0 | 2-c | 95 | 0.5 | 500° C. × 4 h | 1650 | Example of Invention |
| 2-4 | 2-A | 30.8 | 14.0 | 2-d | 90 | 0.5 | 500° C. × 4 h | 2005 | Example of Invention |
| 2-5 | 2-A | 30.8 | 14.0 | 2-e | 85 | 0.5 | 500° C. × 4 h | 2045 | Example of Invention |
| 2-6 | 2-A | 30.8 | 14.0 | 2-f | 75 | 0.5 | 500° C. × 4 h | 2101 | Example of Invention |
| 2-7 | 2-A | 30.8 | 14.0 | 2-g | 70 | 0.5 | 500° C. × 4 h | 2015 | Example of Invention |
| 2-8 | 2-A | 30.8 | 14.0 | 2-h | 60 | 0.5 | 500° C. × 4 h | 953 | Comparative |
| | | | | | | | | | Example |
| 2-9 | 2-A | 30.8 | 14.0 | 2-i | 50 | 0.5 | 500° C. × 4 h | 58 | Comparative |
| | | | | | | | | | Example |
| 2-10 | 2-A | 30.8 | 14.0 | 2-j | 75 | 0 | 500° C. × 4 h | 1289 | Comparative |
| | | | | | | | | | Example |
| 2-11 | 2-A | 30.8 | 14.0 | 2-k | 75 | 0.1 | 500° C. × 4 h | 1758 | Example of Invention |
| 2-12 | 2-A | 30.8 | 14.0 | 2-l | 75 | 0.2 | 500° C. × 4 h | 1890 | Example of Invention |
| 2-13 | 2-A | 30.8 | 14.0 | 2-m | 75 | 0.3 | 500° C. × 4 h | 2099 | Example of Invention |
| 2-14 | 2-A | 30.8 | 14.0 | 2-n | 75 | 0.7 | 500° C. × 4 h | 1983 | Example of Invention |
| 2-15 | 2-A | 30.8 | 14.0 | 2-o | 75 | 0.8 | 500° C. × 4 h | 1901 | Example of Invention |
| 2-16 | 2-A | 30.8 | 14.0 | 2-p | 75 | 0.9 | 500° C. × 4 h | 1809 | Example of Invention |
| 2-17 | 2-A | 30.8 | 14.0 | 2-q | 75 | 1 | 500° C. × 4 h | 851 | Comparative |
| | | | | | | | | | Example |
| 2-18 | 2-A | 30.8 | 14.0 | 2-r | 75 | 0.5 | 500° C. × 4 h | 2002 | Example of Invention |
| 2-19 | 2-A | 30.8 | 14.0 | 2-s | 75 | 0.5 | 500° C. × 4 h | 1860 | Example of Invention |
| 2-20 | 2-A | 30.8 | 14.0 | 2-t | 75 | 0.5 | 500° C. × 4 h | 1822 | Example of Invention |
| 2-21 | 2-A | 30.8 | 14.0 | 2-u | 90 | 0.9 | 500° C. × 4 h | 1731 | Example of Invention |

### Experimental Example 3

An R1-T1-A-X based sintered alloy compact was produced by a similar method to Experimental Example 1, except that the composition (without paying attention to Ti, Al, Si and Mn; Ti was added and mixed in the form of a TiH₂ powder with a D₅₀ of about 5 μm to the fine-pulverized powder so that a sintered compact composition as shown in Table 7 resulted) of a sintered compact was adjusted to result in the composition of Label 3-A shown in Table 7.

TABLE 7

| | R1-T1-A-X based sintered alloy compact composition | | | | | | | | | | | |
|---|---|---|---|---|---|---|---|---|---|---|---|---|
| | (mass %) | | | | | | | | | | [T1]/ | |
| | R1 | | T1 | | | | A | X | | R1 | ([X] − | |
| Label | Nd | Pr | Fe | Al | Si | Mn | Ti | B | C | (mass %) | 2[A]) | [T1]/[X] |
| 3-A | 30.7 | 0.13 | 66.8 | 0.04 | 0.06 | 0.04 | 0.22 | 0.96 | 0.08 | 30.8 | 14.0 | 12.7 |

An R2-Ga—Cu based alloy was produced by a similar method to Experimental Example 1 except for being adjusted so that the alloy composition was the composition of Label 3-a shown in Table 8.

TABLE 8

| | R2-Ga—Cu based | | | | | |
|---|---|---|---|---|---|---|
| | alloy composition (mol %) | | | | | |
| Label | Nd | Pr | Ga | Cu | R2 (mol %) | [Cu]/([Ga] + [Cu]) |
| 3-a | 0 | 75 | 12.5 | 12.5 | 75 | 0.5 |

After the R1-T1-A-X based sintered alloy compact was processed similarly to Experimental Example 1, the R2-Ga—Cu based alloy of Label 3-a and the R1-T1-A-X based sintered alloy compact of Label 3-A were placed so as to be in contact with each other in a manner similar to Experimental Example 1, and a heat treatment and processing were performed similarly to Experimental Example 1 except for adopting the heat treatment temperatures shown in Table 9, whereby samples (sintered R-T-B based magnets) were obtained. The resultant samples were measured by a method similar to Experimental Example 1, thereby determining coercivity (H_{cJ}). The results are shown in Table 9. As indicated in Table 9, high H_{cJ} was obtained when the heat treatment temperature was not less than 450° C. and not more than 600° C.

TABLE 9

| | fabrication conditions | | | | | | | | |
|---|---|---|---|---|---|---|---|---|---|
| | R1-T1-A-X | | | | | | | | |
| | based sintered alloy | | | R2-Ga—Cu based alloy | | | | | |
| | compact composition | | | composition | | | | | |
| sample | | R1 | [T1]/ | | R2 | [Cu]/ | heat | HcJ | |
| No. | Label | (mass %) | [X] | Label | (mol %) | ([Ga]+ [Cu]) | treatment | (kA/m) | NOTES |
| 3-1 | 3-A | 30.8 | 14.0 | 3-a | 75 | 0.5 | 400° C. × | 32 | Comparative |
| | | | | | | | 4 h | | Example |
| 3-2 | 3-A | 30.8 | 14.0 | 3-a | 75 | 0.5 | 450° C. × | 1627 | Example of Invention |
| | | | | | | | 4 h | | |
| 3-3 | 3-A | 30.8 | 14.0 | 3-a | 75 | 0.5 | 500° C. × | 2102 | Example of Invention |
| | | | | | | | 4 h | | |
| 3-4 | 3-A | 30.8 | 14.0 | 3-a | 75 | 0.5 | 600° C. × | 1731 | Example of Invention |
| | | | | | | | 4 h | | |
| 3-5 | 3-A | 30.8 | 14.0 | 3-a | 75 | 0.5 | 700° C. × | 1398 | Comparative |
| | | | | | | | 4 h | | Example |
| 3-6 | 3-A | 30.8 | 14.0 | 3-a | 75 | 0.5 | 800° C. × | 1121 | Comparative |
| | | | | | | | 4 h | | Example |

### Experimental Example 4

An R1-T1-A-X based sintered alloy compact was produced by a similar method to Experimental Example 1, except that the composition (without paying attention to Al, Si and Mn) of a sintered compact was adjusted to result in the compositions of Labels 4-A through 4-F shown in Table 10. Note that each A element was added as a metal of the respective element or as an alloy with Fe, at the time of blending before production of the raw material alloy by a strip casting method.

TABLE 10

| | R1-T1-A-X based sintered alloy compact composition (mass %) | | | | | | | | | | | | | | | [T1]/ | |
|---|---|---|---|---|---|---|---|---|---|---|---|---|---|---|---|---|---|
| | R1 | | T1 | | | | A | | | | | | X | | R1 | ([X] − | [T1]/ |
| Label | Nd | Pr | Fe | Al | Si | Mn | Ti | Zr | Hf | V | Nb | Mo | B | C | (mass %) | 2[A]) | [X] |
| 4-A | 30.7 | 0.13 | 66.8 | 0.04 | 0.06 | 0.04 | 0.22 | 0 | 0 | 0 | 0 | 0 | 0.96 | 0.08 | 30.8 | 14.0 | 12.6 |
| 4-B | 30.6 | 0.12 | 66.7 | 0.04 | 0.05 | 0.04 | 0 | 0.36 | 0 | 0 | 0 | 0 | 0.96 | 0.09 | 30.7 | 13.6 | 12.5 |
| 4-C | 30.5 | 0.13 | 66.8 | 0.03 | 0.05 | 0.04 | 0 | 0 | 0.71 | 0 | 0 | 0 | 0.95 | 0.09 | 30.6 | 13.8 | 12.6 |
| 4-D | 30.6 | 0.13 | 66.6 | 0.03 | 0.05 | 0.04 | 0 | 0 | 0 | 0.22 | 0 | 0 | 0.96 | 0.08 | 30.7 | 13.8 | 12.5 |
| 4-E | 30.7 | 0.12 | 66.5 | 0.03 | 0.05 | 0.04 | 0 | 0 | 0 | 0 | 0.40 | 0 | 0.96 | 0.09 | 30.8 | 13.6 | 12.4 |
| 4-F | 30.7 | 0.12 | 66.6 | 0.04 | 0.05 | 0.04 | 0 | 0 | 0 | 0 | 0 | 0.37 | 0.96 | 0.09 | 30.8 | 13.6 | 12.5 |

An R2-Ga—Cu based alloy was produced by a similar method to Experimental Example 1 except for being adjusted so that the alloy composition was the composition of Label 4-a shown in Table 11.

TABLE 11

| | R2-Ga—Cu based | | | | | |
|---|---|---|---|---|---|---|
| | alloy composition (mol %) | | | | R2 | [Cu]/ |
| Label | Nd | Pr | Ga | Cu | (mol %) | ([Ga] + [Cu]) |
| 4-a | 0 | 75 | 12.5 | 12.5 | 75 | 0.5 |

After the R1-T1-A-X based sintered alloy compact was processed similarly to Experimental Example 1, the R2-Ga—Cu based alloy of Label 4-a and the R1-T1-A-X based sintered alloy compacts of Labels 4-A through 4-F were placed so as to be in contact with each other in a manner similar to Experimental Example 1, and a heat treatment and processing were performed similarly to Experimental Example 1, whereby samples (sintered R-T-B based magnets) were obtained. The resultant samples were measured by a method similar to Experimental Example 1, thereby determining coercivity (H_{cJ}). The results are shown in Table 12. It can be seen from Table 12 that high H_{cJ} was obtained because of both of the R1-T1-A-X based sintered alloy compact and the R2-Ga—Cu based alloy satisfying the constitution according to the present invention.

TABLE 12

| | fabrication conditions | | | | | | | | |
|---|---|---|---|---|---|---|---|---|---|
| | R1-T1-A-X | | | | | | | | |
| | based sintered alloy | | | R2-Ga—Cu based | | | | | |
| | compact composition | | | alloy composition | | | | | |
| sample | | R1 | [T1]/([X] − | | R2 | [Cu]/ | heat | HcJ | |
| No. | Label | (mass %) | 2[A]) | Label | (mol %) | ([Ga]+ [Cu]) | treatment | (kA/m) | NOTES |
| 4-1 | 4-A | 30.8 | 14.0 | 4-a | 75 | 0.5 | 500° C. × | 2085 | Example of Invention |
| | | | | | | | 4 h | | |
| 4-2 | 4-B | 30.7 | 13.6 | 4-a | 75 | 0.5 | 500° C. × | 2077 | Example of Invention |
| | | | | | | | 4 h | | |
| 4-3 | 4-C | 30.6 | 13.8 | 4-a | 75 | 0.5 | 500° C. × | 2051 | Example of Invention |
| | | | | | | | 4 h | | |
| 4-4 | 4-D | 30.7 | 13.8 | 4-a | 75 | 0.5 | 500° C. × | 1638 | Example of Invention |
| | | | | | | | 4 h | | |
| 4-5 | 4-E | 30.8 | 13.6 | 4-a | 75 | 0.5 | 500° C. × | 1871 | Example of Invention |
| | | | | | | | 4 h | | |
| 4-6 | 4-F | 30.8 | 13.6 | 4-a | 75 | 0.5 | 500° C. × | 1831 | Example of Invention |
| | | | | | | | 4 h | | |

### Experimental Example 5

A plurality of R1-T1-A-X sintered alloy compacts were produced by a similar method to Experimental Example 1, except that the composition (without paying attention to Ti, Al, Si and Mn; Ti was added and mixed in the form of a TiH₂ powder with a D₅₀ of about 5 μm to the fine-pulverized powder so that a sintered compact composition as shown in Table 13 resulted) of a sintered compact was adjusted to result in the compositions of Labels 5-A through 5-D shown in Table 13.

TABLE 13

| | R1-T1-A-X based sintered alloy | | | | | | | | | | | |
|---|---|---|---|---|---|---|---|---|---|---|---|---|
| | compact composition (mass %) | | | | | | | | | | [T1]/ | |
| | R1 | | T1 | | | | A | X | | R1 | ([X] − | |
| Label | Nd | Pr | Fe | Al | Si | Mn | Ti | B | C | (mass %) | 2[A]) | [T1]/[X] |
| 5-A | 30.5 | 0.15 | 66.6 | 0.04 | 0.06 | 0.04 | 0.10 | 0.98 | 0.09 | 30.7 | 12.9 | 12.3 |
| 5-B | 30.5 | 0.15 | 66.7 | 0.04 | 0.05 | 0.04 | 0.10 | 0.96 | 0.09 | 30.7 | 13.0 | 12.4 |
| 5-C | 30.4 | 0.16 | 66.7 | 0.04 | 0.06 | 0.04 | 0.09 | 0.94 | 0.08 | 30.6 | 13.3 | 12.7 |
| 5-D | 30.5 | 0.16 | 66.6 | 0.04 | 0.06 | 0.04 | 0.09 | 0.93 | 0.08 | 30.7 | 13.5 | 12.9 |

An R2-Ga—Cu based alloy was produced by a similar method to Experimental Example 1 except for being adjusted so that the alloy composition was the composition of Label 5-a shown in Table 14.

TABLE 14

| | R2-Ga—Cu | | | | |
|---|---|---|---|---|---|
| | based alloy | | | | |
| | composition | | | | |
| | (mol %) | | | R2 | [Cu]/ |
| Label | Pr | Ga | Cu | (mol %) | ([Ga] + [Cu]) |
| 5-a | 75 | 12.5 | 12.5 | 75 | 0.5 |

The R1-T1-A-X based sintered alloy compacts of Labels 5-A through 5-D in Table 13 were each severed and cut into a 4.4 mm×4.4 mm×4.4 mm cube. Next, as shown in FIG. 1, in a processing container 3 made of niobium foils, the R2-Ga—Cu based alloy of Label 5-a shown in Table 14 was placed above and below each R1-T1-A-X based sintered alloy compact of Labels 5-A through 5-D, in such a manner that mainly a face which was perpendicular to the alignment direction (i.e., the direction indicated by arrowheads in the figure) of the R1-T1-A-X based sintered alloy compact 1 was in contact with the R2-Ga—Cu based alloy 2.

Thereafter, in argon which was controlled to a reduced pressure of 200 Pa, a heat treatment was performed at the heat treatment temperature shown in Table 15 by using a tubular flow furnace, followed by cooling. In order to remove any thickened portion in the R2-Ga—Cu based alloy existing in the surface vicinity of each sample after the heat treatment, a surface grinder was used to cut 0.2 mm off the entire surface of each sample, whereby samples respectively in the form of a 4.0 mm×4.0 mm×4.0 mm cube (sintered R-T-B based magnet) were obtained.

[Sample Evaluations]

The resultant samples were magnetized with a pulsed magnetic field of 3.2 MA/m, and thereafter their magnetic characteristics were measured with a BH tracer. Values of coercivity (H_{cJ}) as obtained from the resultant hysteresis curves are shown in Table 15. As shown in Table 15, high H_{cJ} is obtained when the molar ratio of [T1]/([X]−2[A]) is 13.0 or more in the R1-T1-A-X sintered compact. Moreover, as indicated by sample Nos. 5-4 through 5-8, even higher H_{cJ} is obtained when the heat treatment temperature is in the range of not less than 480° C. and not more than 540° C.

TABLE 15

| | fabrication conditions | | | | | | | | |
|---|---|---|---|---|---|---|---|---|---|
| | R1-T1-A-X | | | | | | | | |
| | based sintered alloy | | | R2-Ga—Cu based | | | | | |
| | compact composition | | | alloy composition | | | | | |
| sample | | R1 | [T1]/([X] − | | R2 | [Cu]/([Ga]+ | | HcJ | |
| No. | Label | (mass %) | 2[A]) | Label | (mol %) | [Cu]) | heat treatment | (kA/m) | NOTES |
| 5-1 | 5-A | 30.7 | 12.9 | 5-a | 75 | 0.5 | 500° C. × 8 h | 924 | Comparative |
| | | | | | | | | | Example |
| 5-2 | 5-B | 30.7 | 13.0 | 5-a | 75 | 0.5 | 500° C. × 8 h | 1671 | Example of |
| | | | | | | | | | Invention |
| 5-3 | 5-C | 30.6 | 13.3 | 5-a | 75 | 0.5 | 500° C. × 8 h | 1903 | Example of |
| | | | | | | | | | Invention |
| 5-4 | 5-D | 30.7 | 13.5 | 5-a | 75 | 0.5 | 460° C. × 8 h | 1688 | Example of |
| | | | | | | | | | Invention |
| 5-5 | 5-D | 30.7 | 13.5 | 5-a | 75 | 0.5 | 480° C. × 8 h | 1872 | Example of |
| | | | | | | | | | Invention |
| 5-6 | 5-D | 30.7 | 13.5 | 5-a | 75 | 0.5 | 500° C. × 8 h | 1981 | Example of |
| | | | | | | | | | Invention |
| 5-7 | 5-D | 30.7 | 13.5 | 5-a | 75 | 0.5 | 540° C. × 8 h | 2003 | Example of |
| | | | | | | | | | Invention |
| 5-8 | 5-D | 30.7 | 13.5 | 5-a | 75 | 0.5 | 560° C. × 8 h | 1722 | Example of |
| | | | | | | | | | Invention |

### Experimental Example 6

A plurality of R1-T1-A-X based sintered alloy compacts were produced by a similar method to Experimental Example 1, except that the composition (without paying attention to Ti, Al, Si and Mn; Ti was added and mixed in the form of a TiH₂ powder with a D₅₀ of about 5 μm to the fine-pulverized powder so that a sintered compact composition as shown in Table 16 resulted) of a sintered compact was adjusted to result in the composition of Label 6-A shown in Table 16.

TABLE 16

| | R1-T1-A-X based sintered alloy | | | | | | | | | | | |
|---|---|---|---|---|---|---|---|---|---|---|---|---|
| | compact composition (mass %) | | | | | | | | | | [T1]/ | |
| | R1 | | T1 | | | | A | X | | R1 | ([X] − | |
| Label | Nd | Pr | Fe | Al | Si | Mn | Ti | B | C | (mass %) | 2[A]) | [T1]/[X] |
| 6-A | 30.7 | 0.13 | 66.8 | 0.04 | 0.06 | 0.04 | 0.22 | 0.96 | 0.08 | 30.8 | 14.0 | 12.7 |

By using a Pr metal, a Ga metal, a Cu metal, and an Fe metal (where each metal had a purity of 99% or more), the composition of an alloy was adjusted to result in the compositions of Labels 6-a through 6-c shown in Table 17, and these raw materials were dissolved; thus, by a single roll rapid quenching method (melt spinning method), an alloy in ribbon or flake form was obtained. Using a mortar, the resultant alloy was pulverized in an argon ambient, and thereafter was passed through a sieve with an opening of 425 μm, thereby providing an R2-Ga—Cu based alloy. The composition of the resultant R2-Ga—Cu based alloy is shown in Table 17.

TABLE 17

| | R2-Ga—Cu based alloy | | | | | |
|---|---|---|---|---|---|---|
| | composition (mol %) | | | | R2 | [Cu]/ |
| Label | Pr | Ga | Cu | Fe | (mol %) | ([Ga] + [Cu]) |
| 6-a | 73.9 | 12.3 | 12.3 | 1.5 | 73.9 | 0.5 |
| 6-b | 71.3 | 11.9 | 11.9 | 5.0 | 71.3 | 0.5 |
| 6-c | 67.5 | 11.3 | 11.3 | 10.0 | 67.5 | 0.5 |

After the plurality of R1-T1-A-X based sintered alloy compacts were processed similarly to Experimental Example 5, the R2-Ga—Cu based alloys of Labels 6-a through 6-c and the R1-T1-A-X based sintered alloy compact of Label 6-A were placed so as to be in contact with each other in a manner similar to Experimental Example 5, and a heat treatment and processing were performed similarly to Experimental Example 5 except for adopting the heat treatment temperature shown in Table 6, whereby samples (sintered R-T-B based magnets) were obtained. The resultant samples were measured by a method similar to Experimental Example 5, thereby determining coercivity (H_{cJ}). It can be seen from Table 18 that high H_{cJ} is obtained even when Fe is contained in the R2-Ga—Cu based alloy.

TABLE 18

| | fabrication conditions | | | | | | | | |
|---|---|---|---|---|---|---|---|---|---|
| | R1-T1-A-X | | | | | | | | |
| | based sintered alloy | | | R2-Ga—Cu based | | | | | |
| | compact composition | | | alloy composition | | | | | |
| sample | | R1 | [T1]/ | | R2 | [Cu]/ | | HcJ | |
| No. | Label | (mass %) | ([X] − 2[A]) | Label | (mol %) | ([Ga]+ [Cu]) | heat treatment | (kA/m) | NOTES |
| 6-1 | 6-A | 30.8 | 14.0 | 6-a | 73.9 | 0.5 | 520° C. × 8 h | 2055 | Example of |
| | | | | | | | | | Invention |
| 6-2 | 6-A | 30.8 | 14.0 | 6-a | 71.3 | 0.5 | 520° C. × 8 h | 2032 | Example of |
| | | | | | | | | | Invention |
| 6-3 | 6-A | 30.8 | 14.0 | 6-c | 67.5 | 0.5 | 520° C. × 8 h | 2021 | Example of |
| | | | | | | | | | Invention |

In the specification of Japanese Patent Application No. 2015-029205 as filed (filing date: Feb. 18, 2015), which forms the basis of priority, the C (carbon amount) in 1-A to 1-F of Table 1, 2-A of Table 4, 3-A of Table 7, and 4-A to 4-F of Table 10 were target values; but these have been corrected to measured values.

### INDUSTRIAL APPLICABILITY

A sintered R-T-B based magnet obtained according to the present invention can be suitably used in voice coil motors (VCM) of hard disk drives, various types of motors such as motors for electric vehicles (EV, HV, PHV, etc.) and motors for industrial equipment, home appliance products, and the like.

### REFERENCE SIGNS LIST

1 R1-T1-A-X based sintered alloy compact

2 R2-Ga—Cu based alloy

3 processing container

1. A method for producing a sintered R-T-B (where R is at least one rare-earth element which always includes Nd; T is at least one transition metal element which always includes Fe; and B is partially replaceable with C) based magnet, comprising: a step of providing an R1-T1-A-X (where R1 is at least one rare-earth element which always includes Nd and accounts for not less than 27 mass % and not more than 35 mass %; T1 is Fe, or Fe and M; M is one or more selected from among Ga, Al, Si, Cr, Mn, Co, Ni, Cu, Zn, Ge and Ag; A is at least one of Ti, Zr, Hf, V, Nb and Mo; a molar ratio of [T1]/([X]−2[A]) is not less than 13.0; and X is B, where B is partially replaceable by C) based sintered alloy compact;
a step of providing an R2-Ga—Cu (where R2 is at least one rare-earth element which always includes Pr and/or Nd and accounts for not less than 65 mol % and not more than 95 mol %; and [Cu]/([Ga]+[Cu]) is not less than 0.1 and not more than 0.9 by mole ratio) based alloy; and
a step of, while allowing at least a portion of the R2-Ga—Cu based alloy to be in contact with at least a portion of a surface of the R1-T1-A-X based sintered alloy compact, performing a heat treatment at a temperature which is not less than 450° C. and not greater than 600° C. in a vacuum or an inert gas ambient.

2. The method for producing a sintered R-T-B based magnet of claim 1, wherein T1 in the R1-T1-A-X comprises Fe and M, where M is one or more selected from the group consisting of Al, Si, Cr, Mn, Co, Ni, Cu, Zn, Ge and Ag.

3. The method for producing a sintered R-T-B based magnet of claim 1, wherein a molar ratio of [T1]/([X]−2[A]) in the R1-T1-A-X based sintered alloy compact is 14.0 or more.

4. The method for producing a sintered R-T-B based magnet of claim 1, wherein a molar ratio of [T1]/[X] in the R1-T1-A-X based sintered alloy compact is less than 14.

5. The method for producing a sintered R-T-B based magnet of claim 1, wherein any heavy rare-earth element accounts for 1 mass % or less of the R1-T1-A-X based sintered alloy compact.

6. The method for producing a sintered R-T-B based magnet of claim 1, wherein the R1-T1-A-X based sintered alloy compact is provided by pulverizing a raw material alloy to a size of not less than 1 μm and not more than 10 μm, thereafter pressing the pulverized raw material alloy in a magnetic field, and performing sintering.

7. The method for producing a sintered R-T-B based magnet of claim 1, wherein no heavy rare-earth element is contained in the R2-Ga—Cu based alloy.

8. The method for producing a sintered R-T-B based magnet of claim 1, wherein Pr accounts for 50 mol % or more of the R2 in the R2-Ga—Cu based alloy.

9. The method for producing a sintered R-T-B based magnet of claim 1, wherein, in the step of performing a heat treatment, an R1₂T1₁₄X phase in the R1-T1-A-X based sintered alloy compact reacts with a liquid phase occurring from the R2-Ga—Cu based alloy to generate an R₆T₁₃Z phase (where Z always includes Ga and/or Cu) at least partially inside the sintered magnet.

10. The method for producing a sintered R-T-B based magnet of claim 1, wherein the temperature in the step of performing a heat treatment is not less than 480° C. and not more than 540° C.
